(19) United States
(12) Patent Application Publication
(10) Pub. No.: US 2013/0006720 A1
(43) Pub. Date: Jan. 3, 2013

(54) System and Method for Creating Limited Edition Product

(76) Inventor: Louis Monoyudis, New York, NY (US)

(21) Appl. No.: 13/539,174

(22) Filed: Jun. 29, 2012

Related U.S. Application Data
(60) Provisional application No. 61/503,590, filed on Jun. 30, 2011.
(60) Provisional application No. 61/595,637, filed on Feb. 6, 2012.

(51) Int. Cl. G06Q 30/06; G07C 13/00

(52) U.S. Cl. 705/12

(57) ABSTRACT

An method and system for partnering with fashion and design industries to create limited-edition, exclusive product. A designer is asked to submit 3-4 sketches each of 4-6 related styles in a collection, along with swatches of fabrics and colorways of the fabrics. Buyers each select, for each style in the collection, a preferred combination of silhouette, fabric and color and the system records each selection through a Multilateral Voting Matrix on an e-commerce platform.

This application claims priority to U.S. Provisional Patent applications Ser. No. 61/503,590 filed Jun. 29, 2011 and 61/595,637 filed Feb. 6, 2012.

### BACKGROUND OF THE INVENTION

It is believed that the most exciting aspects of being a fashion designer are the selection of silhouette, fabric and color. Unfortunately, consumers seldom have an opportunity to participate in decisions as to these selections. As it stands, designers design and consumers consume, and there is no dialogue between the two before a style is sent into production.

Competitors in the crowd-sourced fashion space include Threadless, Modcloth, Gannz and Fashionstake. Crowdsourcing, or crowd-sourcing, is an inclusive term that generally covers any commercial phenomenon that includes reference in some way to public input. Typically, for these sites the input is either the submission of individual designs from the public for consideration by a commercial production company, or simple yes-no voting on a slate of designs presented by the production company. In such instances, the few styles that are available for voting are a small percentage of styles for sale, and it is not the primary focus of the site.

In addition, no one is currently working with high-end fashion designers such as Zac Posen, Philip Lim, Derek Lam, Thom Browne, at extended and elevated levels of advance consumer interaction to create flash sales of uniquely designed high fashion product.

### DISCLOSURE OF THE INVENTION

An e-commerce or social commerce platform that partners with the fashion and design industries to create limited-edition, exclusive product by leveraging crowdsourcing, game mechanics and social shopping concepts is disclosed.

This technology allows consumers access to crowdsource design decisions across several metrics such as (but not limited to) silhouette, fabric and color. Contemplated designer partners in the disclosed system will also benefit from this technology in that they are given real-time pre-production customer information about design decisions. The disclosed technology is advantageously applied to many design areas such as clothing and accessories, and also to home product design such as rugs, tables and other furniture.

The system turns a conventional fashion paradigm on its head. Instead of designers (for instance clothing designers) creating the next wave of fashion and then asking buyers to buy those designs, the disclosed system asks designers to first submit 3-4 sketches each of 4-6 related styles in a collection, along with swatches of fabrics for which they have availability and the colorways of the fabrics all to a selected e-commerce platform. The disclosed system then provides access to buyers, aspiring designers and other consumers to each select, for each style in the collection, a preferred combination of silhouette, fabric and color and have that selection recorded through engagement with a “Multilateral Voting Matrix” on the e-commerce platform. Each member of the public thus “votes” on her combination choice, and that choice or vote is recorded, tabulated with all other votes, and the combination choices with the most votes are declared winners, and the winning choices in each design collection are then presented to the public for limited edition purchase, preferably in a flash-sale modality (inter alia including time limitations on the duration of the sale and or discounts).

The consumer is anyone who wants to participate in the design decisions and/or purchase items from the site. It is possible that boutique buyers may purchase several items from the site, but to that extent the intent is to provide a direct-to-consumer process. For example, a limited purchase of 3 items of the same style is set up for each registered user login. The site will be open for anyone to view, but consumers must register with a username and password (or optionally more simply by using their Facebook connect) to vote or purchase.

Preferably, only a registered consumer is able to “vote” (select favorite combinations of silhouette, fabric and color). Generally no advance commitment to buy is required in order to vote, as anyone who is a registered user of the site can vote. Once the flash sale for the winning item(s) goes live, registered users can buy but only during a limited time flash sale time window. Buyers are required to pay some amount up front (say, 50%) to secure their item during the flash sale. As there is desirably no existing inventory, all items are placed into production after the flash sale is concluded, and the purchased winning styles are delivered directly to buyers after the close of the sale, in some short time frame appropriate to conventional manufacturing requirements (typically 8 weeks or so for clothing items, and 12 weeks for home products).

### Multilateral Voting Matrix

This matrix organizes the selections of silhouette, fabric and color for each submitted design in the designer's proposed collection. Interaction with the matrix is the means by which the consumer creates his/her favorite combination. One layout is a grid; other layouts are contemplated as well. The exact format of the grid or layout is flexible to accommodate the needs and options presented by the designer and to accommodate the product being designed, but it is easiest to explain the concept as a 3×3 grid.

In this example, on the top row are 3 sketches of a style. The second and third rows each represent a fabric and the colors respectively in which the style is available. In this example, there would be 2 fabrics with 3 colors each.

X X X (3 silhouette sketches)
X X X (3 colorways of fabric 1)
X X X (3 colorways of fabric 2)

Other layouts are also possible from this same structure. For example, if there are 4 fabrics all available in 4 colors, then the grid looks like this:

X X X X (4 silhouette sketches, additional sketch added for symmetry of layout)
X X X X (4 colorways of fabric 1)
X X X X (4 colorways of fabric 2)
X X X X (4 colorways of fabric 3)
X X X X (4 colorways of fabric 4)

Note that the contents of the grid can change. For example, if we are working with a furniture designer on a table, the grid is:

X X X (3 silhouette sketches of the table)
X X X (3 wood tabletop swatches)
X X X (3 metal finishes for the legs)

Or, if working with a beauty brand on a new eye shadow configuration (eye shadows are sometimes packaged in color groupings):

X X X (matte color options)
X X X (glitter accent color options)
X X X (glossy color options)
X X X (packaging color decision)
X X X (packaging shape decision)
X X X (packaging material decision)

It is desirable to keep the voting live for a time to generate buzz around the item(s) that are up for interaction with the Multi-Lateral Voting Matrix. The system is selectably optimizable to know instantly what the winning style combo is, at the end of a selected voting time frame window, for each voting invitation. At the close of the window, the winning style may be immediately announced, or briefly delayed to curry further buzz and excitement around the contest and the proposed designs.

Once the winning styles are announced, the flash sale, with a limited edition one time only production run (optionally occurring only if enough people (‘all in’) purchase the style), begins immediately for the duration of its own time window, typically a matter of several hours, rather than days, but that too is selectable to accommodate different designers and their designs or other items or other concerns.

An “all in” limit which is the critical flash sale metric is set based on production minimums with the factory. Users will know how many “editions” for each winning style are up for sale in the flash sale. It is expected that most editions will be limited to 50-300 pieces.

After each buying commitment, a reminder of purchase, manufacture, and shipping information are all automated and sent for each buyer/user. Non-registered users generally cannot make purchases, but registered users who did not vote are still able to buy anything they want.

To incent the consumer to interact with the Multilateral Voting Matrix, there is an optional gaming element. Anyone who is a registered member of the site can purchase the winning style during the flash sale for the listed price. Those who participated in the design process are offered a discount (i.e. 10% or 15%). Those who participated and who created the winning style (the winners) are offered a deeper discount (i.e. 20%-25%).

### BRIEF DESCRIPTION OF THE DRAWINGS

FIGS. 1-7 are schematic page illustrations for an embodiment of the disclosed technology.

### BEST MODE

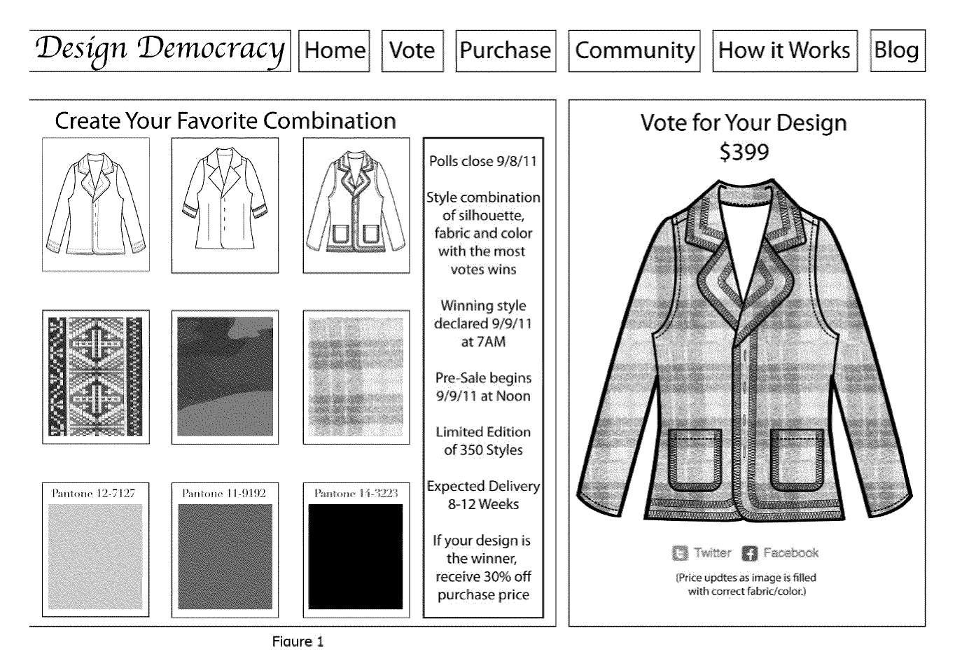

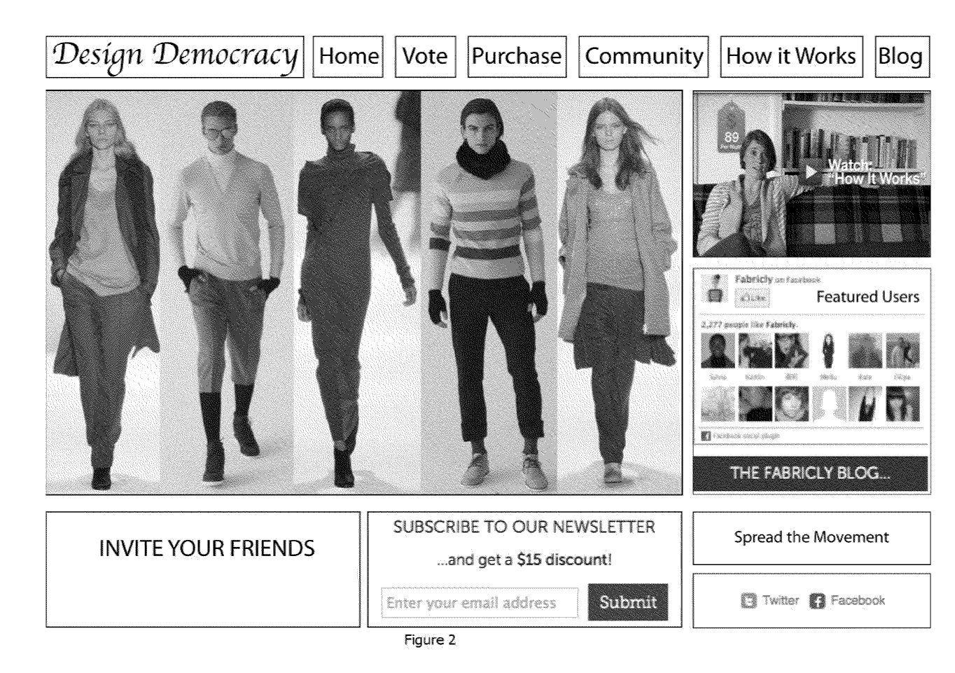

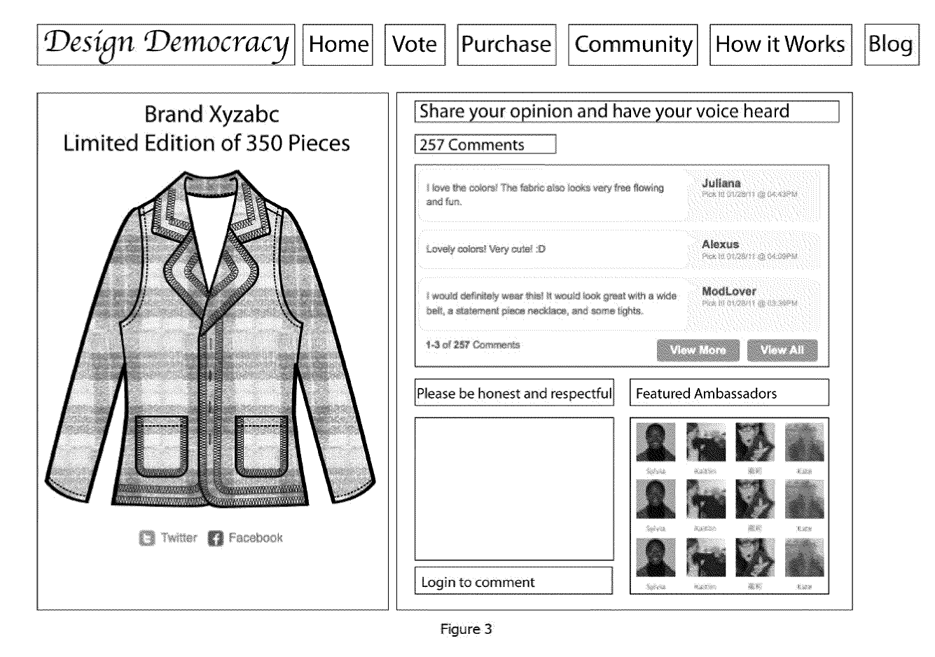

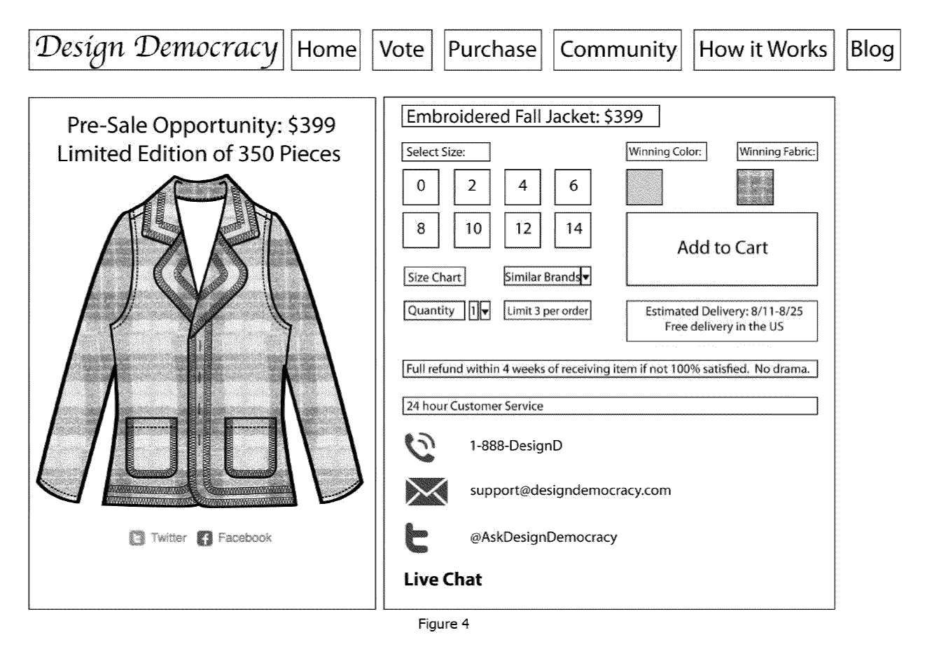

FIG. 1 is a VotingBooth—on the top row are 3 sketches. Each following row represents a fabric and the colors in which it is available. In the figure there are 3 fabrics, each available in 3 colors. FIG. 2 is typical HomepagePictures. FIG. 3 is an ItemDiscussionPage. FIG. 4 is a PurchasePage.

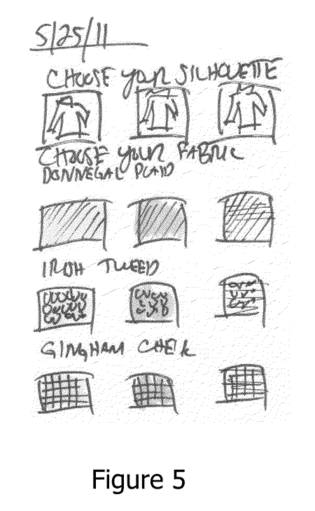

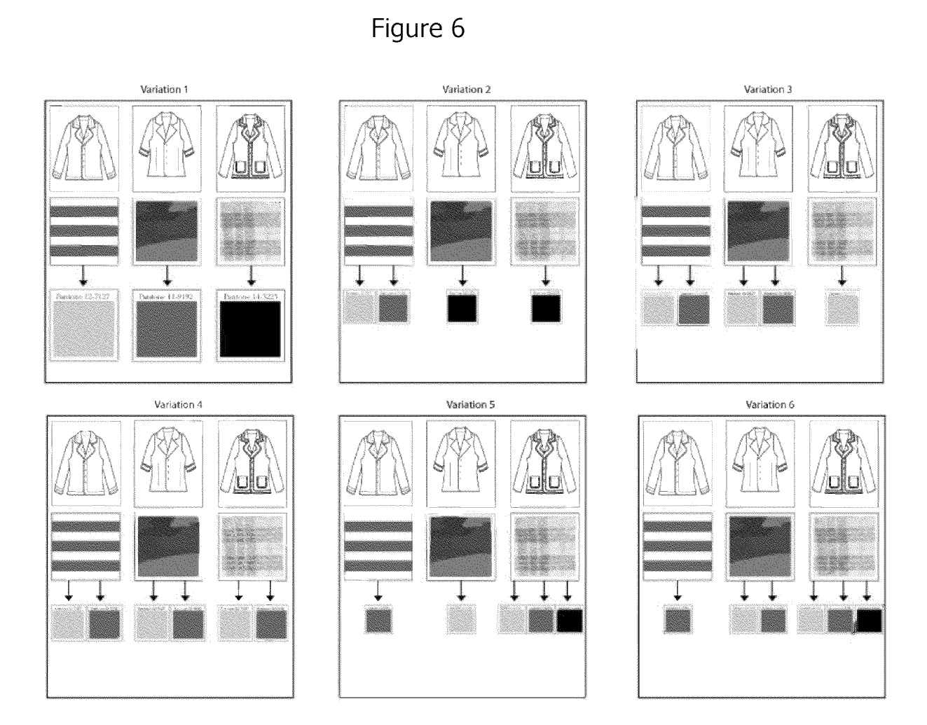

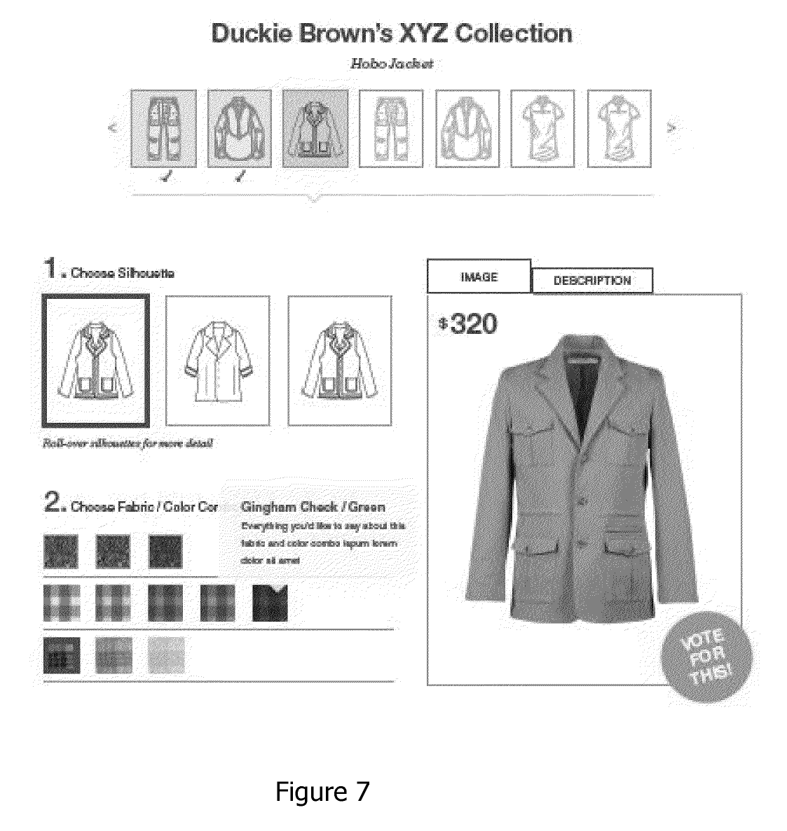

FIG. 5 illustrates a version of the “Multilateral Voting Matrix”, where the fabric and color selection are combined into a one click choice. FIGS. 6 and 7 are alternate Voting Matrices. FIG. 7 illustrates an updated version of the “Multilateral Voting Matrix”, where the fabric and color selection are combined into a one click choice.

I claim:

1. An e-commerce method including:
partnering with fashion and design industries to create limited-edition, exclusive product;
asking a designer to submit 3-4 sketches each of 4-6 related styles in a collection, along with swatches of fabrics and colorways of the fabrics;
providing access to a plurality of buyers to each select, for each style in the collection, a preferred combination of silhouette, fabric and color;
recording each selection through a Multilateral Voting Matrix on an e-commerce platform.
